(19) United States
(12) Patent Application Publication
(10) Pub. No.: US 2023/0184562 A1
(43) Pub. Date: Jun. 15, 2023

(54) SYSTEM AND METHOD FOR CONTROLLING VEHICLE

(71) Applicants: Hyundai Motor Company, Seoul (KR); Kia Corporation, Seoul (KR)

(72) Inventor: Young Sung Joo, Hwaseong (KR)

(21) Appl. No.: 17/892,368

(22) Filed: Aug. 22, 2022

(30) Foreign Application Priority Data
Dec. 14, 2021 (KR) 10-2021-0179079

(51) Int. Cl. G01C 21/36; G01S 19/13

(52) U.S. Cl. CPC G01C 21/3667; G01S 19/13

(57) ABSTRACT

A system for controlling a vehicle includes a route guidance device configured to generate a first route to a destination, and a vehicle control device configured to generate a second route to the destination, receives the first route, and outputs the first route and the second route. Therefore, it may be possible to allow a user to easily compare the information provided by the navigation device built into a vehicle with the route information provided by the route guidance device, and allow the user to select a desired route, thereby improving user satisfaction and driving stability.

### CROSS-REFERENCE TO RELATED APPLICATION

This application claims under 35 U.S.C. § 119(a) the benefit of priority to Korean Patent Application No. 10-2021-0179079, filed in the Korean Intellectual Property Office on Dec. 14, 2021, the entire contents of which may be incorporated herein by reference.

### BACKGROUND

### Technical Field

The present disclosure relates to a system and method for controlling a vehicle.

### Background Description

A navigation device built into a vehicle may calculate a driving route based on vehicle's location information, but it may be impossible to receive driving route information in real time at a location where a satellite signal cannot be easily received. An Over The Air (OTA) function may be used to update a new map, but in the case of a vehicle that does not support the OTA, the user has to perform the update directly, which leads to inconvenience to the user.

Accordingly, in recent years, a route guidance device for guiding a route to a destination may be provided separately, or by downloading a route guidance application to a smart device, the user may use a vehicle-built navigation as well as a route guidance device to obtain the route information to the destination.

However, because the user has to alternately check the information provided by the navigation device built-in in the vehicle and the route information provided by the route guidance device or smart device, the forward gaze may be neglected, which may cause an accident, so that it may be difficult to secure safe driving.

### SUMMARY

The present disclosure has been made to solve the above-mentioned problems occurring in the existing technology while advantages achieved by the existing technology may be maintained intact.

An exemplary embodiment of the present disclosure provides a system and a method for controlling a vehicle that may allow a user to easily compare information provided from a navigation device built into the vehicle and route information provided from a route guidance device, and to allow the user to select a desired route.

The technical problems to be solved by the present disclosure may not be limited to the aforementioned problems, and any other technical problems not mentioned herein will be clearly understood from the following description by those skilled in the art to which the present disclosure pertains.

According to an exemplary embodiment of the present disclosure, a system for controlling a vehicle may include a route guidance device that is configured to generate a first route to a destination, and a vehicle control device that is configured to generate a second route to the destination, receive the first route, and output the first route and the second route.

The vehicle control device may be configured to control an output device by dividing a display of the output device into a first output screen and a second output screen

The vehicle control device may control the output device to display the second route to be output to the first output screen and the first route to be output to the second output screen having a smaller area than the first output screen.

The vehicle control device may control the output device to display the first route and the second route on an entire screen of the output device by overlapping the first route and the second route.

The vehicle control device may be configured to generate an output of a pop-up message configured to be displayed on the output device that guides a junction at which the first route and the second route start to be separated from each other.

The vehicle control device may guide to reselect a route from the junction to the destination, and combine the route from a departure point to the junction with the reselected route to recalculate a first driving distance and a first driving time when the pop-up message may be touched by a user.

The vehicle control device may be configured to receive a route selection by a user to determine a selected route and to output a message informing that a route change occurs before a specified distance from a junction where the route change occurs when the route change occurs in the selected route while driving along the selected route selected by a user.

The vehicle control device may output a first message for guiding a first driving distance and a first driving time when driving along the selected route, and output a second message for guiding a second driving distance and a second driving time when driving along the changed route.

The vehicle control device may guide the changed route when the user selects the changed route.

The vehicle control device may guide the selected route when the user arrives at the junction without selecting the changed route.

According to an exemplary embodiment of the present disclosure, a method of controlling a vehicle may include generating, by a route guidance device, a first route to a destination, and generating, by a vehicle control device, a second route to the destination, receiving the first route, and outputting the first route and the second route.

The vehicle control device may be configured to control an output device to be divided into a first output screen and a second output screen.

The vehicle control device may be configured to control the output device to display the second route to be output to the first output screen and the first route to be output to the second output screen having a smaller area than the first output screen.

The vehicle control device may be configured to control the output device to display the first route and the second route to be output on an entire screen of the output device by overlapping the first route and the second route.

The method may further include outputting, by the vehicle control device, a pop-up message that guides a junction at which the first route and the second route start to be separated from each other.

The method may further include guiding, by the vehicle control device, to reselect a route from the junction to the destination, and combining the route from a departure point to the junction with the reselected route to recalculate a driving distance and a driving time when the pop-up message may be touched by a user.

The method may further include outputting, by the vehicle control device, a message informing that a route change occurs before a specified distance from a junction where the route change occurs when the route change occurs in the selected route while driving along the selected route selected by a user.

The vehicle control device may output a first message for guiding a first driving distance and a first driving time when driving along the selected route, and output a second message for guiding a second driving distance and a second driving time When driving along the changed route.

The vehicle control device may guide the changed route when the user selects the changed route.

The vehicle control device may guide the selected route when the user arrives at the junction without selecting the changed route.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating the configuration of a system for controlling a vehicle according to an embodiment of the present disclosure;

FIG. 2 is a block diagram illustrating the configuration of a vehicle control device according to an embodiment of the present disclosure;

FIG. 3 is a block diagram illustrating the configuration of a route guidance device according to an embodiment of the present disclosure;

FIG. 4 is a diagram illustrating an output device according to an embodiment of the present disclosure;

FIGS. 5 to 8 are diagrams illustrating an output screen according to an embodiment of the present disclosure;

FIGS. 9 and 10 are flowcharts illustrating a method of controlling a vehicle according to an embodiment of the present disclosure; and

FIG. 11 is a block diagram illustrating a computing system for executing a method according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms may be merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that may be consistent with their meaning in the context of the relevant art and will not be interpreted in an idealized or overly formal sense unless expressly so defined herein.

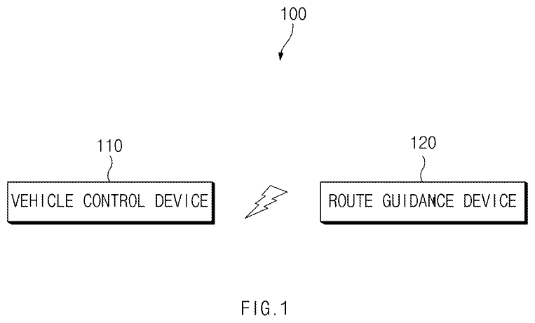

FIG. 1 is a block diagram illustrating the configuration of a system for controlling a vehicle according to an embodiment of the present disclosure.

As shown in FIG. 1, a system 100 for controlling a vehicle may include a vehicle control device 110 and a route guidance device 120.

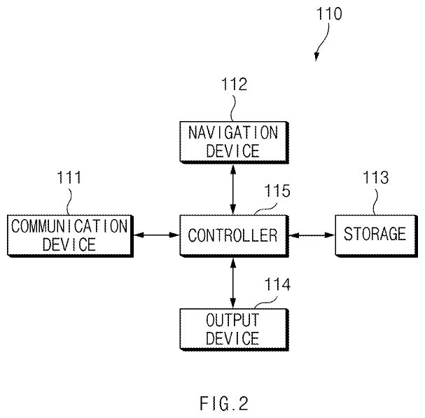

The vehicle control device 110 may be configured to receive a first route to a destination generated by the route guidance device 120 from the route guidance device 120, may be configured to generate a second route to the destination, and may be configured to output the first route and the second route together. For more details, refer to FIG. 2.

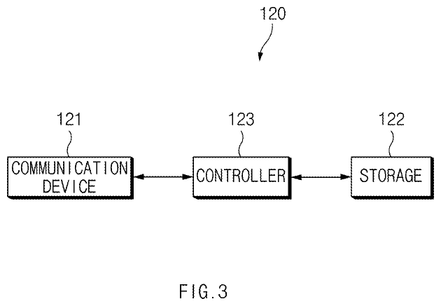

The route guidance device 120 may be configured to generate the first route to the destination. The route guidance device may be implemented as a portable navigation device or a portable device. When the first route may be generated by wireless communication with the vehicle control device 110, the route guidance device may transmit the first route to the vehicle control device 110. For more details, refer to FIG. 3.

FIG. 2 is a block diagram illustrating the configuration of a vehicle control device according to an embodiment of the present disclosure.

As shown in FIG. 2, the vehicle control device 110 may include a communication device 111, a navigation device 112, storage 113, an output device 114, and a controller 115.

The communication device 111 may wirelessly communicate with the route guidance device 120 while interworking with the route guidance device 120 through Bluetooth. In addition, the communication device 111 may communication with the route guidance device 120 in various wireless communication schemes such as Wi-Fi, WiBro, global system for mobile communication (GSM), code division multiple access (CDMA), wideband code division multiple access (WCDMA), universal mobile telecommunication system (UMTS), time division multiple access (TDMA), long term evolution (LTE), and the like.

The navigation device 112 may be provided with a Global Positioning System (GPS) receiver to receive the current location of the vehicle, and may provide map image information of a certain area based on the current location of the vehicle, route information from the departure point to the destination, speed information of the vehicle, and the like. The navigation device 112 may include a display device and a sound output device. The display device may be applied with a touch display, and may be implemented integrally with the output device 114.

The storage 113 may store at least one algorithm for performing operations or executions of various commands for the operation of the vehicle control device according to an embodiment of the present disclosure. The storage 113 may include at least one storage medium of a flash memory, a hard disc, a memory card, a read-only memory (ROM), a random access memory (RAM), an electrically erasable programmable read-only memory (EEPROM), a programmable read-only memory (PROM), a magnetic memory, a magnetic disk, and an optical disk

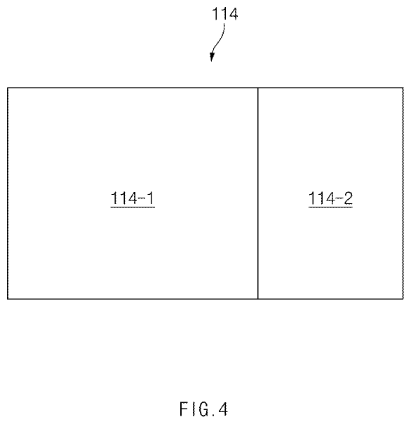

The output device 114 may include a display device or a sound output device. A touch display may be applied to the display device to generate an input signal corresponding to a touch input of a user. For a more detailed description of the output device 114, refer to FIG. 4. FIG. 4 is a diagram illustrating an output device according to an embodiment of the present disclosure. 100541 According to an embodiment of the present disclosure, as shown in FIG. 4, the output device 114 may be configured to divide the entire screen into a first output screen 114-1 and a second output screen 114-2 under control of the controller 115 to output information. Alternatively, information may be output through the entire screen without any divisions.

The controller 115 may be implemented with various processing devices such as a microprocessor and the like in which a semiconductor chip capable of performing operations or executions of various commands may be built-in, and may control operations of the vehicle control device according to an embodiment of the present disclosure.

The controller 115 may be configured to search for a device capable of interworking through Bluetooth when the vehicle may be in a turn-on state. According to an embodiment, it may be possible to search whether there may be the route guidance device 120 capable of interworking through Bluetooth.

The controller 115 may determine whether a route guidance device capable of interworking through Bluetooth may be searched and the route guidance device 120 may be connected. When it may be determined that the route guidance device 120 may be connected, the controller 115 may determine whether the route guidance device 120 may be in a Wi-Fi communication state. When it may be determined that the route guidance device may not be connected, the controller 115 may be configured to output a pop-up message for guiding the search for a Bluetooth device and search for devices capable of interworking through Bluetooth again.

When it may be determined that the route guidance device 120 may be in a Wi-Fi communication state, the controller 115 may perform Wi-Fi wireless communication with the route guidance device 120. When it may be determined that the route guidance device 120 may not be in a Wi-Fi communication state, the controller 115 may request the route guidance device 120 to start Wi-Fi communication.

When a destination may be input by the user through the navigation device 112, the navigation device 112 may generate a route (hereinafter, referred to as the second route for convenience) from the departure point (current location) to the destination. In addition, the controller 115 may receive the first route from the departure point to the destination generated by the route guidance device 120, and output the first route and the second route. The received first route may be output while being optimized for driving of the vehicle. The first route and the second route may include a plurality of major junctions.

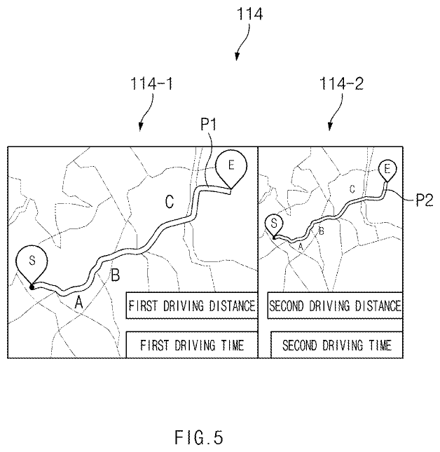

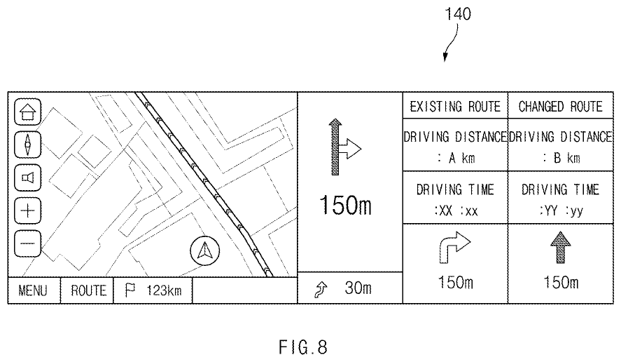

The controller 115 may be configured to set a scheme of outputting the first route and the second route in one or more modes specified, and may output it through the output device 114 so that the user may select one or more modes. For more details, refer to FIGS. 5 to 8.

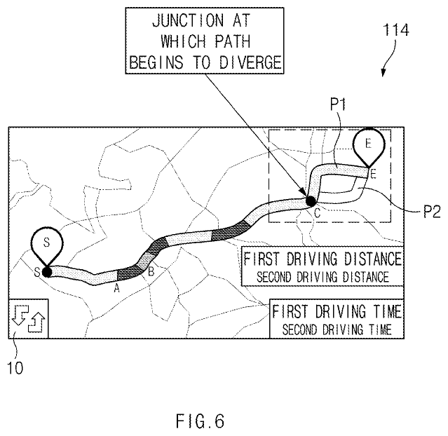

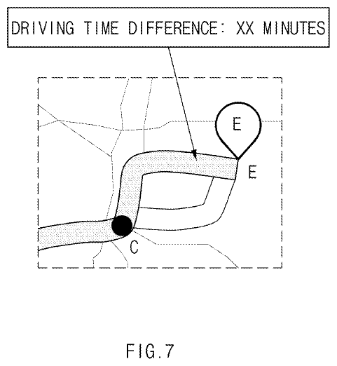

FIGS. 5 to 8 are diagrams illustrating an output screen according to an embodiment of the present disclosure. FIG. 5 shows an output screen output when the first mode may be selected. FIG. 6 shows an output screen output when the second mode may be selected. FIG. 7 shows an output screen output when the third mode may be selected.

According to an embodiment, as shown in FIG. 5, the controller 115 may be configured to output a second route P1 to the first output screen 114-1. In addition, the controller 115 may be configured to calculate the first driving distance and the first driving time from the departure point “S” to the destination “E” when driving along the second route P1, and may be configured to output the driving distance and the driving time to the first output screen 114-1.

In addition, the controller 115 may be configured to output a first route P2 to the second output screen 114-2. In addition, the controller 115 may be configured to output the second driving distance and the second driving time from the departure point “S” to the destination “E” to the second output screen 114-2 when driving along the first route P2.

According to an embodiment, as shown in FIG. 6, the controller 115 may be configured to overlap and output the first route P2 and the second route P1 through the entire screen of the output device 114. When a route change icon 10 may be touched by the user, the controller 115 may activate one of the first route P2 and the second route P1, and may display the activated route together with the amount of traffic.

In addition, the controller 115 may be configured to output the first driving distance and the first driving time from the departure point to the destination when driving along the second route P1, and output the second driving distance and the second driving time from the departure point “S” to the destination “E” when driving along the first route P2. According to an embodiment, the controller 115 may be configured to output the first driving distance and the first driving time at a font size larger than that of the second driving distance and the second driving time. In addition, the controller 115 may be configured to output a pop-up message guiding the junction “C” at which the first route P2 and the second route P1 start to be separated from each other.

When the pop-up message of FIG. 6 is touched by the user, as shown in FIG. 7, the controller 115 may be configured to guide the reselection of the route from the junction “C” to the destination “E”, and combine the route reselected by the user with the route from the departure point “S” to the junction “C” to recalculate the driving distance and the driving time. When a difference occurs between the recalculated driving time and the driving time before the recalculation, the controller 115 may be configured to output the difference of the driving time as a pop-up message.

After the first route P2 and the second route P1 may be guided according to the embodiments of FIGS. 5 to 7, when a route may be selected by the user, the controller 115 may guide the user through the output device 114, thereby allowing the user to drive along the route selected by the user.

When a route change occurs in the selected route while the user drives along the selected route, the controller 115 may be configured to inform that the route change occurs before a specified distance from a junction where the route change occurs.

According to an embodiment, the controller 115 may be configured to output a route change guidance message of “A route change has occurred at a point X km ahead” through the output device 114. The controller 115 may output the above-described route change guidance message when the vehicle has to go through a gas station due to insufficient fuel, or when the route may be re-searched to reflect real-time traffic information and the route may be changed.

The controller 115 may be configured to output a first message guiding the driving distance and the driving time when driving along the selected route, and output a second message guiding the driving distance and the driving time when driving along the changed route. According to an embodiment, the controller 115 may be configured to display the first message and the second message in different colors to intuitively check the information on the selected route and the information on the changed route. In this case, the changed route may include a route searched by the navigation device 112, and may include a route received from the route guidance device 120.

The controller 115 may be configured to determine whether the route changed by the user may be selected. When it may be determined that the user has selected the changed route, the controller 115 may guide the changed route. Meanwhile, when it may be determined that the user has not selected the changed route, the controller 115 may be configured to guide the selected route after reaching the junction.

FIG. 3 is a block diagram illustrating the configuration of a route guidance device according to an embodiment of the present disclosure.

As shown in FIG. 3, the route guidance device 120 may include a communication device 121, storage 122, and a controller 123.

The communication device 121 may perform wireless communication while interworking with the vehicle control device 110 through Bluetooth. In addition, the communication device 121 may communication with the vehicle control device 110 in various wireless communication schemes such as Wi-Fi, WiBro, global system for mobile communication (GSM), code division multiple access (CDMA), wideband code division multiple access (WCDMA), universal mobile telecommunication system (UMTS), time division multiple access (TDMA), long term evolution (LTE), and the like.

The storage 122 may store at least one algorithm for performing operations or executions of various commands for the operation of the vehicle control device according to an embodiment of the present disclosure. The storage 122 may include at least one storage medium of a flash memory, a hard disc, a memory card, a read-only memory (ROM), a random access memory (RAM), an electrically erasable programmable read-only memory (EEPROM), a programmable read-only memory (PROM), a magnetic memory, a magnetic disk, and an optical disk.

The controller 123 may be implemented with various processing devices such as a microprocessor and the like in which a semiconductor chip capable of performing operations or executions of various commands may be built-in, and may control operations of the route guidance device according to an embodiment of the present disclosure.

When receiving a request for Wi-Fi communication from the vehicle control device 110, the controller 123 may be configured to activate Wi-Fi communication. When Wi-Fi communication may be activated, the controller 123 may be configured to communicate with the vehicle control device 110 through Wi-Fi.

When destination information may be input through an input device separately provided, the controller 123 may be configured to generate a route (first route) from the departure point to the destination. The controller 123 may be configured to receive destination information from the vehicle control device 110.

When the first route may be generated, the controller 123 may be configured to transmit the first route to the vehicle control device 110. In addition, when a route change occurs after the first route may be generated, the changed route may be transmitted to the vehicle control device 110.

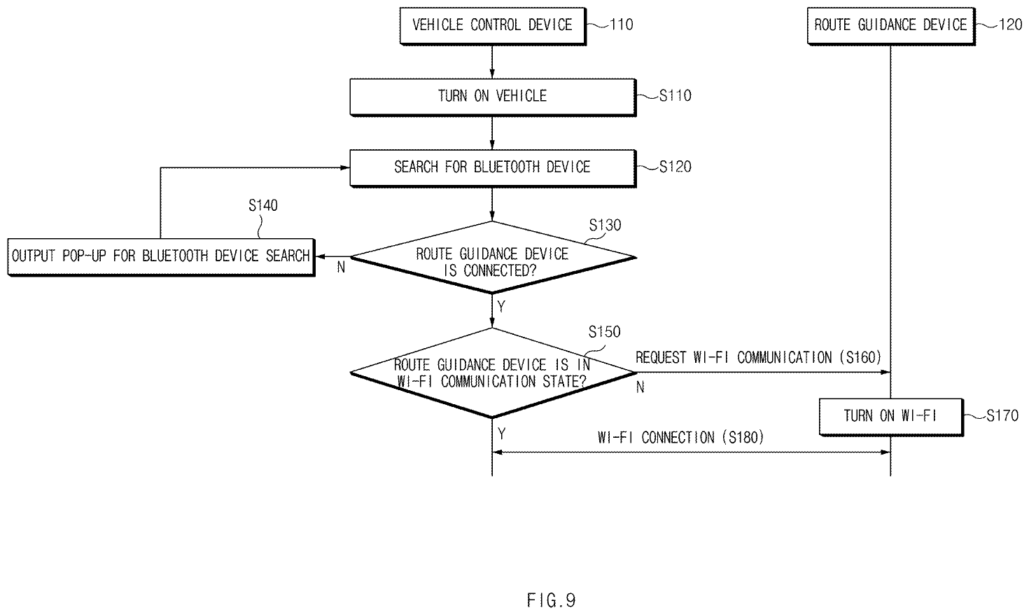

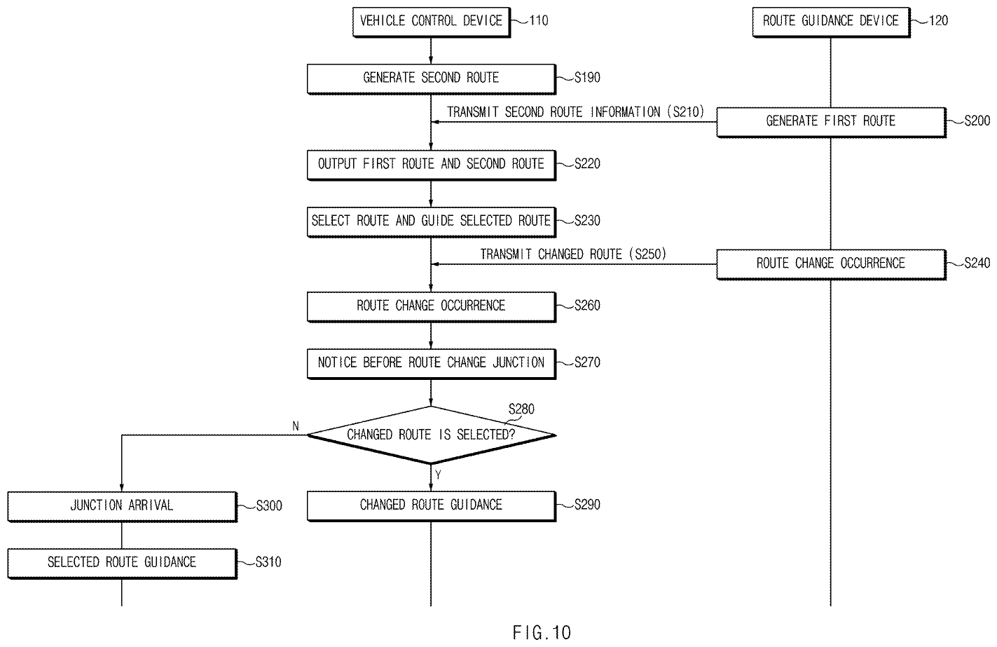

FIGS. 9 and 10 are flowcharts illustrating a method of controlling a vehicle according to an embodiment of the present disclosure.

As shown in FIG. 9, the vehicle control device 110 may turn on the vehicle's ignition in S110. When the vehicle is turned on, the vehicle control device 110 may search for a device capable of interworking with Bluetooth in S120. In S120, according to an embodiment, it is possible to search whether there is the route guidance device 120 capable of interworking through Bluetooth.

In S130, the vehicle control device 110 may determine whether the route guidance device 120 is connected by searching for a route guidance device capable of interworking through Bluetooth.

When it is determined in S130 that the route guidance device 120 is connected (Y), in S150, the vehicle control device 110 may determine whether the route guidance device 120 is in a Wi-Fi communication state.

When it is determined in S130 that the route guidance device is not connected (N), in S140, the vehicle control device 110 may output a pop-up message guiding the Bluetooth device search and re-search for devices capable of interworking through Bluetooth.

When it is determined in S150 that the route guidance device 120 is in a Wi-Fi communication state (Y), in S180, the vehicle control device 110 may perform Wi-Fi wireless communication with the route guidance device 120. When it is determined in S150 that the route guidance device 120 is not in a Wi-Fi communication state (N), in S160, the vehicle control device 110 may request the route guidance device 120 to start Wi-Fi communication. When receiving a Wi-Fi communication request from the vehicle control device 110, the route guidance device 120 may activate (turn on) Wi-Fi communication and perform Wi-Fi wireless communication with the vehicle control device 110 in S180.

As shown in FIG. 10, when a destination is input by the user through the navigation device 112, in S190, the vehicle control device 110 may generate a route (hereinafter, referred to as a second route for convenience) from a departure point (current location) to a destination.

When destination information is input through an input device separately provided, in S200, the route guidance device 120 may generate a route (first route) from the departure point to the destination. According to an embodiment, the route guidance device 120 may receive destination information from the vehicle control device 110.

When the first route is generated, in S210, the route guidance device 120 may transmit the first route to the vehicle control device 110.

In addition, the vehicle control device 110 may receive the first route from the departure point to the destination generated by the route guidance device 120, and output the first route and the second route in S220. The received first route may be optimized for driving of the vehicle and output. The first route and the second route may include a plurality of major junctions.

In S220, the vehicle control device 110 may set a scheme of outputting the first route and the second route into one or more modes, and output the modes through the output device 114 such that the user selects one or more modes. For more details, refer to FIGS. 5 to 8.

In S230, when a route is selected by the user after the first route P2 and the second route P1 are guided according to the embodiments of FIGS. 5 to 7, the vehicle control device 110 may guide the user through the output device 114 to allow the user to drive along the selected route.

When it is determined in S240 that a route change occurs after the first route is generated, the route guidance device 120 may transmit the changed route to the vehicle control device 110 in S250.

When it is determined in S260 that a route change occurs in the selected route while the user drives along the selected route, in S270, the vehicle control device 110 may guide that the route change occurs before a specified distance from the junction where the route change occurs.

According to an embodiment, in S270, the vehicle control device 110 may output a route change guidance message of “a route change has occurred at a point of X km ahead” to the output device 114. The vehicle control device 110 may output the above-described route change guidance message when the vehicle has to go through a gas station due to insufficient fuel, or when the route is re-searched to reflect real-time traffic information and the route is changed.

According to the embodiment, in S270, the vehicle control device 110 may output a first message for guiding the driving distance and driving time when driving along the selected route, and output a second message for guiding the driving distance and driving time when driving along the changed route. According to an embodiment, the vehicle control device 110 may display the first message and the second message in different colors to intuitively check the information on the selected route and the information on the changed route. In this case, the changed route may include a route searched for by the navigation device 112, and may include a route received from the route guidance device 120.

In S280, the vehicle control device 110 may determine whether the changed route is selected by the user. When it is determined that the user selects the changed route, in S290, the vehicle control device 110 may guide the changed route.

Meanwhile, when it is determined in S280 that the user does not select the changed route (N), and when it is determined in S300 that the junction is reached, the vehicle control device 110 may guide the selected route in S310.

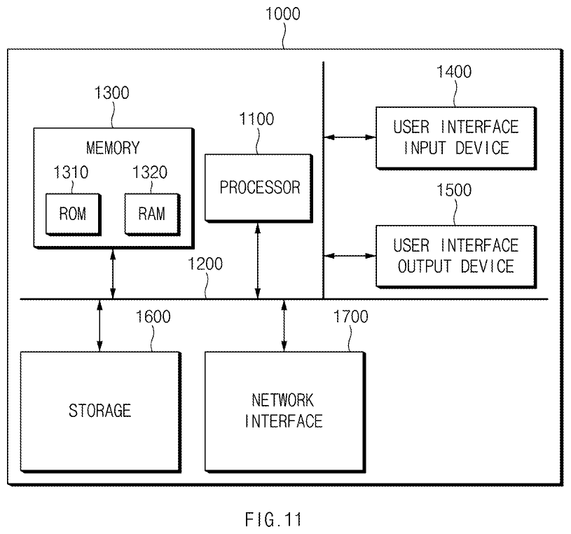

FIG. 11 is a block diagram illustrating a computing system for executing a method according to an embodiment of the present disclosure.

Referring to FIG. 11, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the method or algorithm described in relation to the embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disc, solid state drive (SSD), a detachable disk, or a CD-ROM. The exemplary storage medium may be coupled to the processor 1100, and the processor 1100 may read information from the storage medium and may write information in the storage medium. In another method, the storage medium may be integrated with the processor 1100. The processor and the storage medium may reside in an application specific integrated circuit (ASIC). The ASIC may reside in a user terminal. In another method, the processor and the storage medium may reside in the user terminal as an individual component.

The system and method for controlling a vehicle according to the embodiments of the present disclosure may allow a user to easily compare the information provided by the navigation device built into a vehicle with the route information provided by the route guidance device, and allow the user to select a desired route, thereby improving user satisfaction and driving stability.

As described herein, a controller, navigation device, or other electronic device may be shown or described as having outputs or outputting information, pop-ups, routes, distances, destinations, times, etc. As described herein, an output may be instructions and/or data that may be interpreted by another electronic device, such as a display or other output device, and provided to a user. An output may also be a direct output to the user, such as the actual display of a pop-up or the described information on a display screen. The display may therefore be integrated into the navigation device or separate therefrom wherein the navigation device communicates with the display and may control the display by providing the instructions and/or information to generate an image on the display or other output device.

Although exemplary embodiments of the present disclosure have been described for illustrative purposes, those skilled in the art will appreciate that various modifications, additions and substitutions are possible, without departing from the scope and spirit of the disclosure.

Therefore, the exemplary embodiments disclosed in the present disclosure are provided for the sake of descriptions, not limiting the technical concepts of the present disclosure, and it should be understood that such exemplary embodiments are not intended to limit the scope of the technical concepts of the present disclosure. The protection scope of the present disclosure should be understood by the claims below, and all the technical concepts within the equivalent scopes should be interpreted to be within the scope of the right of the present disclosure.

What is claimed is:

1. A system for controlling a vehicle, the system comprising:
a route guidance device configured to generate a first route to a destination; and
a vehicle control device configured to generate a second route to the destination, receive the first route, and output the first route and the second route.

2. The system of claim 1, wherein the vehicle control device is configured to control an output device to divide a display of the output device into a first output screen and a second output screen.

3. The system of claim 2, wherein the vehicle control device is configured to control the output device to display the second route to be output to the first output screen and the first route to be output to the second output screen having a smaller area than the first output screen.

4. The system of claim 1, wherein the vehicle control device is configured to control an output device to display the first route and the second route on an entire screen of the output device by overlapping the first route and the second route.

5. The system of claim 1, wherein the vehicle control device is configured to output a pop-up message configured to be displayed on the output device that guides a junction at which the first route and the second route start to be separated from each other.

6. The system of claim 5, wherein the vehicle control device is configured to guide to reselect a route from the junction to the destination when the pop-up message is touched by a user, and combine the route from a departure point to the junction with the reselected route to recalculate a driving distance and a driving time.

7. The system of claim 1, wherein the vehicle control device is configured to receive a route selection by a user to determine a selected route and to output a message informing that a route change occurs before a specified distance from a junction where the route change occurs when the route change occurs in the selected route while driving along the selected route selected by a user.

8. The system of claim 7, wherein the vehicle control device is configured to output a first message for guiding a first driving distance and a first driving time when driving along the selected route, and output a second message for guiding a second driving distance and a second driving time when driving along a changed route.

9. The system of claim 8, wherein the vehicle control device is configured to guide the changed route when the user selects the changed route.

10. The system of claim 9, wherein the vehicle control device is configured to guide the selected route when the user arrives at the junction without selecting the changed route.

11. A method of controlling a vehicle, the method comprising:
generating, by a route guidance device, a first route to a destination; and
generating, by a vehicle control device, a second route to the destination, receiving the first route, and outputting the first route and the second route.

12. The method of claim 11, wherein the vehicle control device is configured to control an output device to be divided into a first output screen and a second output screen.

13. The method of claim 12, wherein the vehicle control device is configured to control the second route to be output to the first output screen and the first route to be output to the second output screen having a smaller area than the first output screen.

14. The method of claim 12, wherein the vehicle control device is configured to control the first route and the second route to be output on an entire screen of the output device by overlapping the first route and the second route.

15. The method of claim 11, further comprising:
outputting, by the vehicle control device, a pop-up message that guides a junction at which the first route and the second route start to be separated from each other.

16. The method of claim 15, further comprising:
guiding, by the vehicle control device, to reselect a route from the junction to the destination, when the pop-up message is touched by a user; and
combining the route from a departure point to the junction with the reselected route to recalculate a driving distance and a driving time.

17. The method of claim 11, further comprising:
outputting, by the vehicle control device, a message informing that a route change occurs before a specified distance from a junction Where the route change occurs when the route change occurs in a selected route while driving along the selected route selected by a user.

18. The method of claim 17, wherein the vehicle control device is configured to output a first message for guiding a first driving distance and a first driving time when driving along the selected route, and output a second message for guiding a second driving distance and a second driving time when driving along a changed route.

19. The method of claim 18, wherein the vehicle control device is configured to guide the changed route when the user selects the changed route.

20. The method of claim 19, wherein the vehicle control device is configured to guide the selected route when the user arrives at the junction without selecting the changed route.
